(19) United States
(12) Patent Application Publication
(10) Pub. No.: US 2021/0130081 A1
(43) Pub. Date: May 6, 2021

(54) CARRIAGE FOR DIFFERENT ELEMENTS OF A CRANE TO BE LOADED IN A CONTAINER

(71) Applicant: KONECRANES GLOBAL CORPORATION, Hyvinkää (FI)

(72) Inventors: Jaakko REINVALL, Helsinki (FI); Joonas KEKKONEN, Espoo (FI); Henrik LAAKKONEN, Tampere (FI); Visa NUMMELA, Riihimäki (FI); Eetu LEHIKOINEN, Hyvinkää (FI); Raine JUSSILA, Hämeenlinna (FI)

(73) Assignee: KONECRANES GLOBAL CORPORATION, Hyvinkää (FI)

(21) Appl. No.: 16/478,913

(22) PCT Filed: Jan. 18, 2018
(86) PCT No.: PCT/FI2018/050038

§ 371 Date: Jul. 18, 2019

(30) Foreign Application Priority Data
Jan. 19, 2017 (FI) U20174013

(51) Int. Cl. B65D 85/68; B66C 23/28; B66C 19/02; B62B 3/02

(52) U.S. Cl. CPC B65D 85/68; B66C 23/286; B62B 2202/10; B62B 3/02; B66C 19/02

(57) ABSTRACT

A carriage for different elements of a crane to be loaded in a container includes open end frames at both ends of the carriage, whereby both end frames have substantially vertical side parts and a bottom horizontal lower intermediate part connecting them; side beams horizontally interconnecting the end frames by their sides and vertically positioned at a distance from each other; side storage compartments arranged one above the other at the sides of the carriage; and wheels installed on the end frames, of which the wheels of at least one of the end frames are turnable.

### BACKGROUND OF THE INVENTION

The invention relates to a carriage for different elements of a crane to be loaded in a container. The carriage is suited for bringing elements of a movable and dismantlable crane inside a container and storing these elements in the container as the crane is transported to different sites or as the crane is stored away. Typically in such a case, the container itself also forms part of the crane.

In prior art movable crane systems, in which the container constitutes part of the system in question, the other elements of the crane have been loaded in the container without any assisting means. It is obvious that this always requires careful arrangement of the elements in the container so that everything fits in appropriately and remains undamaged during container transportation. This slows down the loading and unloading of the container. The parts will not always end up in an optimum order and definitely not in the same way every time. If the various elements do not have any support structures during transport, the danger is that some parts get damaged, if they have the chance to move during transport, or if vulnerable elements have been stacked one on top of the other. In addition, each part has to be individually brought in and placed in the container as well as individually brought out. All this naturally takes up a lot of time when the placement of elements always needs to though over anew and caution needs to be exercised when elements are unloaded.

### SUMMARY OF THE INVENTION

The object of the invention is to solve the problem described above. This object is achieved with the carriage according to the invention, which is mainly characterised in that it comprises open end frames at both ends of the carriage, whereby both end frames have substantially vertical side parts and a bottom horizontal lower intermediate part connecting them; side beams horizontally interconnecting the end frames by their sides and vertically positioned at a distance from each other; side storage compartments arranged one above the other on the sides of the carriage; and wheels installed on the end frames, of which the wheels of at least one of the end frames are turnable.

In this case, the main girder of a bridge crane, for example, even with its trolleys, may be supported on top of the lower intermediate parts. Longitudinal support structures of the crane may be placed in the side storage compartments.

The carriage particularly advantageously comprises, installed in the corners of the end frame, vertical forks each having two fork parts at a distance from each other. It is in such a case further advantageous that adjacent forks in each end frame are at different heights and so installed that forks located at the same height in opposite end frames are located on different sides of these end frames. This means that the longest parts of a crane may be placed on the forks crosswise one on top of the other.

Other preferred embodiments of the invention are disclosed in the dependent claims.

The solution according to the invention solves the problems described in the above in a simple and economical manner, because the costs of the carriage according to the invention are very low and just a fraction of the price of the actual crane that is dismantled. Loading the crane elements into and unloading them from the container also takes up only a fraction of what it used to. At the same time the crane parts remain undamaged since they are always placed in their set places well protected.

### LIST OF FIGURES

The invention will now be explained in more detail with reference to the accompanying drawings, in which

FIG. 1 is a perspective view showing a carriage according to the invention;

FIG. 2 shows a carriage according to the invention, loaded with elements of a movable crane and ready to be transferred to a container;

FIG. 3 shows a carriage according to the invention, loaded with elements of a movable crane and ready to be transferred to a container, as viewed from the opposite direction in relation to FIG. 2; and

FIG. 4 shows a detachable drawbar of a carriage.

### DETAILED DESCRIPTION OF THE INVENTION

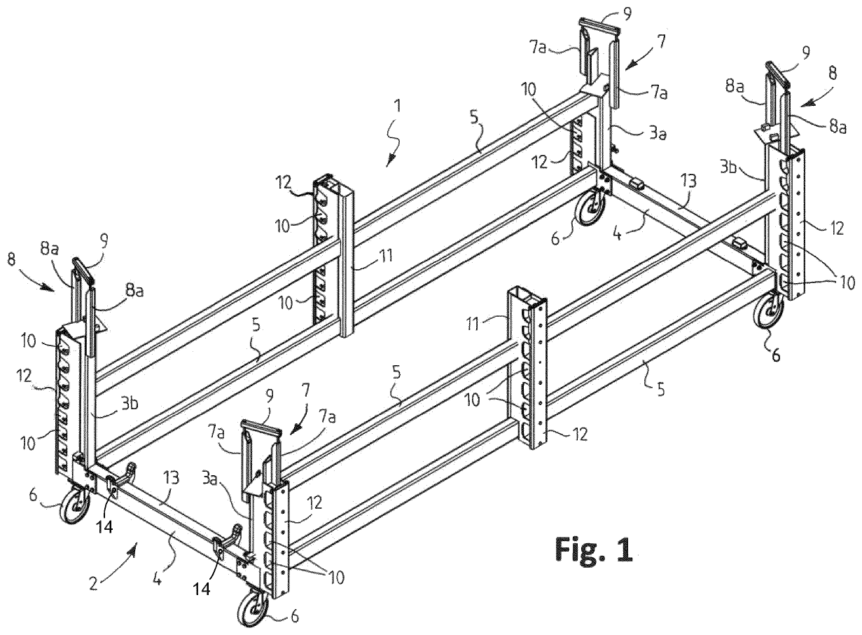

With reference to FIG. 1, an advantageous implementation is presented of the carriage 1 for different elements of a crane to be loaded in a container.

The carriage comprises open end frames 2 at both ends of the carriage 1, whereby both end frames 2 have substantially vertical side parts 3a and 3b and a bottom horizontal lower intermediate part 4 connecting them; side beams 5 horizontally interconnecting the end frames 2 by their sides and vertically positioned at a distance from each other; side storage compartments 10 arranged one above the other on the sides of the carriage; and wheels 6 installed on the end frames 2, of which the wheels 6 of at least one of the end frames 2 are turnable.

The carriage 1 now disclosed additionally comprises, installed in the corners of the end frame 2, vertical forks 7 and 8 each having two fork parts 7a and 8a at a distance from each other. The forks 7 and 8 may be of different lengths.

Adjacent forks 7 and 8 in each end frame 2 are at different heights and so installed that forks 7 and 8 located at the same height in opposite end frames 2 are located on different sides of these end frames 2. This difference in height is most advantageously implemented in such a way that the parallel side parts 3a and 3b on both end frames 2, to which side parts 3a and 3b the forks 7 and 8 are installed, are of different heights and so positioned that the side parts 3a and 3b of the same height at opposite end frames 2 are located on different sides of these end frames 2.

Both end frames 2 may be identical, but when they are turned facing each other on the opposite ends of the carriage 1, their side parts 3a and 3b at different heights are set on different sides of the carriage 1.

Advantageously, the forks 7 and 8 at the same height in opposite end frames 2 are turned towards each other, whereby a line passing through fork parts 7a, 8a of one fork 7, 8 is advantageously substantially parallel with the line passing through fork parts 6a, 7a of the other, similar fork 7, 8 on the other side and other end of the carriage 1.

The top ends of the fork parts 7a, 8a of each fork 7, 8 are connected by a detachable connecting part 9 so that the crane elements placed on the forks 7, 8 stay in place.

The side storage compartments 10 are arranged on the outer sides of the vertical side parts 3a, 3b and side beams 5 of the end frames 2, whereby the side storage compartments 10 on both sides of the carriage 1 are at each particular time in the same line for the straight elements of the crane to be installed in them.

The side storage compartments 10 on the outer sides of the side beams 5 are arranged on a vertical connecting beam 11 which interconnects the side beams 5 that are one above the other. In this example, on both sides of the carriage 1, there is one connecting beam 11, with its side storage compartments, 10 at the centre of the side beams 5, but if need be there could be more of these entities.

The side storage compartments 10 have, for reasons of expediency, open sides, whereby each entity consisting of side storage compartments 10 one above the other may be closed by a vertical locking element 12 closing the open sides. This locking beam may at each particular time be connected at its top end by a hinge to the connecting beam 11.

The vertical side parts 3a and 3b, lower intermediate parts 4 of the end frames, as well as the connecting beams 11 are advantageously formed of hollow, rectangular profiles, such as steel profiles.

On the vertical side parts 3a and 3b of the end frames, on the inside of the carriage 1, there may also be transport fasteners (not shown in the drawings) for the moving mechanisms (2 pcs.) of the crane, which usually have to be separated for the crane to fit inside the container as concerns its length.

On the top surface of the lower intermediate parts 4 of the end frames, a wear-resistant loading base 13 is also arranged, such as one made of wood, plastic, or rubber material.

The carriage 1 may be assembled out of the components described in the above, by partly welding and partly using bolt or screw fastenings. Bolt or screw fastenings may also be used exclusively, in which case the carriage 1, too, may be entirely dismantled.

The required separate bolts and screws may be in dedicated enclosures (not shown in the drawings), which may be connected to the carriage 1 in question.

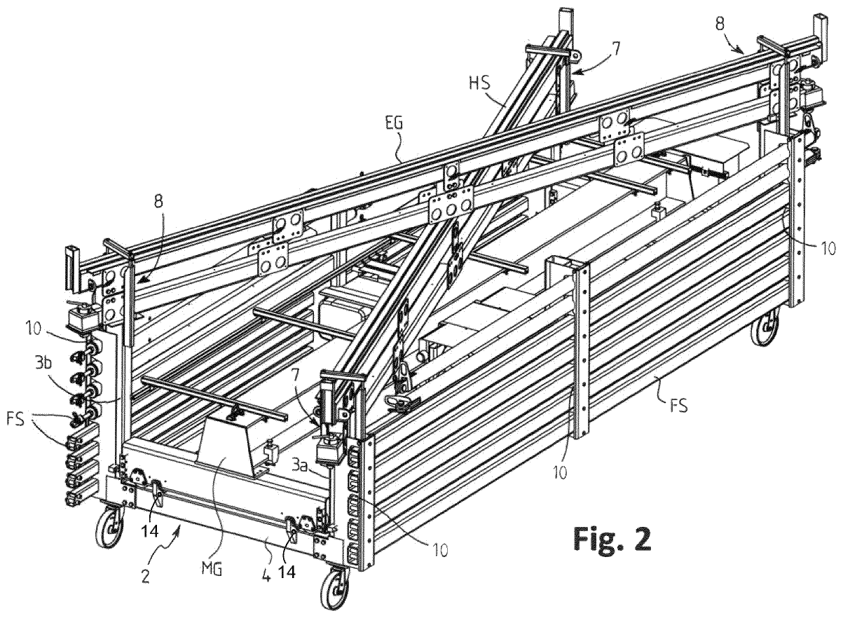

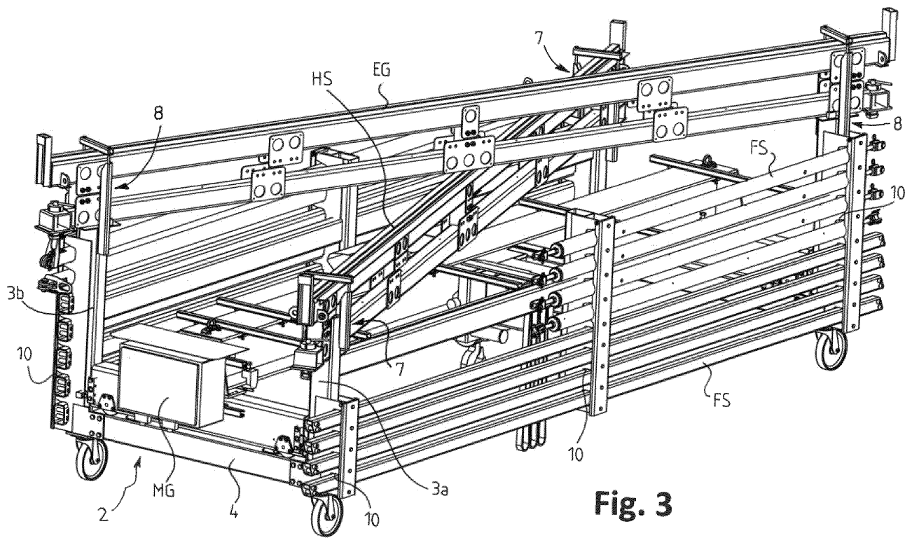

FIGS. 2 and 3 show how the different elements of a crane to be moved may be positioned in the carriage 1 described above.

The main girder MG of the crane with its trolleys may be placed longitudinally on the lower intermediate parts 4 whereby the space between the end frames 2, defined by the side parts 3a, 3b and the lower intermediate parts 4 of the end frames 2, is mainly reserved for the main girder MG, which is the most valuable and heaviest part taking up the most space.

The longest parts of the crane, such as end girders EG and its horizontal support structures HS, may be placed on the forks 7 and 8 crosswise one on top of the other (by using a suitable protection at the intersection for the elements in contact one on top of the other).

Other support structures FS of the crane, which are shorter than the aforementioned support structures HS placed crosswise and whose diameter dimensions are correspondingly smaller, may be placed in the side storage compartments 10.

All the aforementioned parts may be secured to the carriage 1 by load straps and/or suitable screw or bolt fastenings easy to detach.

The carriage 1 according to the invention may be placed to a container opening at its end, or equally well to a container opening at its side, as long as the carriage 1 is designed to fit in the container through these openings. When the carriage 1 is taken into a container through its end, it is enough that the wheels 6 at one end of the carriage 1 are turnable. If, on the other hand, a carriage 1 is taken in a container through a side, it makes sense for the wheels 6 to be turnable at both ends of the carriage 1.

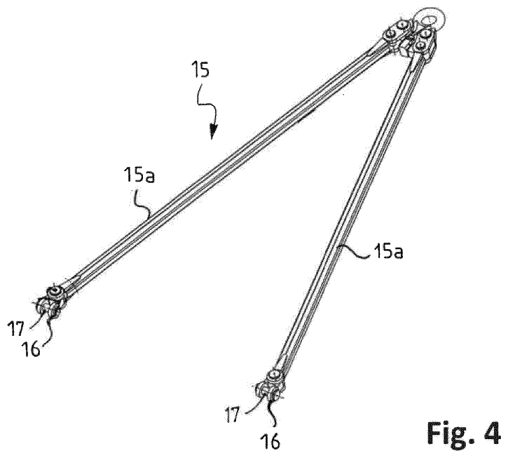

For the purpose of moving the carriage 1, a drawbar 15 of FIG. 4 may be installed in lug openings 14 of one lower intermediate part 4 by means of corresponding lugs 16 made at the ends of drawbar parts 15a and locking pins 17 installed through them.

A track, along which the carriage 1 may be moved into the container, may comprise a U beam fixed with wood screws to the bottom plywood board of the container. The middle part of the track may in such a case be fastened with positioning pegs to the track on the container side, with the other end resting on the track on the ground, being positioned to it with positioning pegs, too. The “middle” part of the track is slanting, that is, it is upraised on the container side and the other end is lower at the ground level. On the ground side, the track is fixed to a film plywood board. The track in question is not shown in the drawings.

The above description of the invention is only intended to illustrate the basic idea of the invention. A person skilled in the art may therefore implement its details within the scope of the attached claims. Consequently, the side storage compartments, for example, may alternatively be formed at least partly of side beams interconnecting the ends, although such a structure is not separately shown in the drawings.

1. A carriage for different elements of a crane to be loaded in a container, comprising:
open end frames at both ends of the carriage, the end frames have substantially vertical side parts and a bottom horizontal lower intermediate part connecting them;
side beams horizontally interconnecting the end frames by sides thereof and vertically positioned at a distance from each other;
side storage compartments arranged one above the other at the sides of the carriage; and
wheels installed on the end frames, wherein the wheels of at least one of the end frames are turnable.

2. The carriage as claimed in claim 1, further comprising, installed in the upper corners of the end frame, vertical forks each having two fork parts at a distance from each other.

3. The carriage as claimed in claim 2, that wherein adjacent forks in each end frame are at different heights and so installed that forks located at the same height in opposite end frames are located on different sides of the end frames.

4. The carriage as claimed in claim 3, wherein the parallel side parts in both end frames, to which side parts the forks are installed, are of different heights and so positioned that the side parts of the same height in opposite end frames are located on different sides of the end frames.

5. The carriage as claimed in claim 3, wherein the forks at the same height in opposite end frames are turned towards each other, whereby a line passing through fork parts of one fork is advantageously substantially parallel with the line passing through fork parts of the other, similar fork on the other side and other end of the carriage.

6. The carriage as claimed in claim 2, wherein the top ends of the fork parts of each fork are connected by a detachable connecting part.

7. The carriage as claimed in claim 1, wherein the side storage compartments are arranged on the outer sides of the vertical side parts and side beams of the end frames, whereby the side storage compartments on both sides of the carriage are at each particular time in the same line for the straight elements of the crane to be installed in them.

8. The carriage as claimed in claim 7, wherein the side storage compartments on the outer sides of the side beams are arranged on a vertical connecting beam which interconnects the side beams that are one above the other.

9. The carriage as claimed in claim 8, wherein the side storage compartments have open sides, whereby each entity consisting of side storage compartments one above the other may be closed by a vertical locking element closing the open sides.

10. The carriage as claimed in claim 1, wherein the vertical side parts and the lower intermediate parts of the end frames are formed of hollow, rectangular profiles.

11. The carriage as claimed in claim 8, wherein the vertical side parts, the lower intermediate parts of the side frames, as well as the connecting beams are formed of hollow, rectangular profiles.

12. The carriage as claimed in claim 1, wherein a wear-resistant loading base is arranged on the top surface of the lower intermediate parts of the end frames.

13. The carriage as claimed in claim 1, wherein a drawbar is arranged to be installed in lug openings of one of the lower intermediate parts.

14. The carriage as claimed in claim 4, wherein the forks at the same height in opposite end frames are turned towards each other, whereby a line passing through fork parts of one fork is advantageously substantially parallel with the line passing through fork parts of the other, similar fork on the other side and other end of the carriage.

15. The carriage as claimed in claim 10, wherein the hollow, rectangular profiles are steel profiles.

16. The carriage as claimed in claim 12, wherein the hollow, rectangular profiles, are steel profiles.

17. The carriage as claimed in claim 12, wherein the wear-resistant loading base is made of wood, plastic or rubber material.
